(19) United States
(12) Patent Application Publication
(10) Pub. No.: US 2010/0265033 A1
(43) Pub. Date: Oct. 21, 2010

(54) HANDS-FREE FUELING CONTROL SYSTEM

(75) Inventor: BYRON C. CHEUNG, MENLO PARK, CA (US)

Correspondence Address: HAYNES BEFFEL & WOLFELD LLP, P O BOX 366, HALF MOON BAY, CA, 94019, US

(73) Assignees: FLEET DATA SYSTEMS, LLC, REDWOOD CITY, CA (US); 4REFUEL HOLDINGS LTD., LANGLEY, CA (US)

(21) Appl. No.: 12/426,131

(22) Filed: Apr. 17, 2009

(51) Int. Cl. G08B 29/00; B65B 1/30

(52) U.S. Cl. 340/5.64; 141/94

(57) ABSTRACT

Roughly described, a fueling control system includes a nozzle module for use with a particular fuel dispensing nozzle, a vehicle module for use with a particular fuel tank inlet, and a site controller. The nozzle module, in response to predefined user activation behavior such as removal of the nozzle from an on-hook position and insertion into the inlet of a fuel tank, wirelessly transmits a wake-up signal and an identification of the particular nozzle. The vehicle module, in response to detection of the wake-up signal, awakens from a low power mode to an active mode, detects the transmitted nozzle identification, and wirelessly requests authorization for the particular nozzle to dispense fuel. The site controller, in response to detection of the nozzle identification, authorizes dispensing of fuel through the particular nozzle.

### BACKGROUND OF THE INVENTION

The invention relates to fuel management systems, such as those used to authorize refueling of fleet vehicles.

Many organizations have fleets of vehicles, and have a refueling station for these vehicles on their property. In order to prevent fuel theft by unauthorized vehicles, or merely in order to keep track of fuel usage by individual vehicles, the refueling stations are often designed to require the user or vehicle to establish their authority to receive fuel from the station, before the station site control system will turn on the fuel dispenser. A variety of different mechanisms have been employed to allow the user to establish such authorization. In various systems authorization is accomplished by the user (often the vehicle's driver) inserting an identification card into a reader associated with the particular desired dispenser, or bringing an RFID tag into proximity with a tag reader, or even entering a code on a keyboard at the fueling island. Two problems with manual keyboard entry systems are that the user may have to remember long codes, and entry of such codes can be subject to error. A problem with card authorization systems is that cards can be lost, stolen or forged.

In one prior art system that avoids the above problems, a transponder module is mounted on or in the vehicle, and is connected to an antenna ring which encircles the inlet of the vehicle's fuel tank. Another antenna wire is mounted on each dispenser nozzle, and connected to a base station. When the user inserts the nozzle into the vehicle's fuel inlet, the transponder module in the vehicle transmits a vehicle identification code via the two antennas to the base station. The base station determines the vehicle's authority to receive fuel, and then turns on the fuel dispenser associated with nozzle from which the vehicle identification code was received.

While this system works well, the antenna wire can be difficult to install on the nozzles and to wire to the base station. The antenna and connection wire are also subject to breakage, and can be difficult to maintain. The antenna ring on the vehicle's fuel inlet also can be difficult to install and maintain, because it has to be wired to the transponder module, which in turn has to be wired to the vehicle's battery. Depending on where the transponder module is located in or on the vehicle, either the antenna wires or the battery wires or both must be routed through hidden or protected areas of the vehicle exterior and interior, which is time consuming at best. For some vehicles, the fuel inlet also lacks sufficient clearance for the antenna ring to fit around it.

Another prior art system which avoids some of these problems uses an RFID tag embedded on a plastic or fiberglass ring encircling the nose of the nozzle, instead of an antenna wired to the base station. The antenna ring on the inlet of the vehicle's fuel tank remains, but is operated differently. In this system, when the user inserts the nozzle into the vehicle's fuel inlet, the transponder in the vehicle reads the nozzle ID from the RFID tag via the antenna ring at the fuel inlet. The transponder then transmits the nozzle ID as well as a vehicle ID wirelessly to the base station. The base station then determines the vehicle's authority to receive fuel, and turns on the fuel dispenser associated with the nozzle on which the indicated RFID tag was mounted.

This system avoids the difficulty with installing and maintaining a nozzle antenna and connection wire, but other problems arise instead. In particular, maintenance personnel repairing or replacing the nozzles sometimes neglect to replace the RFID ring on the nozzle after repair, or sometimes even fail to notice its presence on a nozzle being replaced. Both of these issues will cause the vehicle transponder to fail to receive a nozzle ID, so the dispenser will never turn on. In addition, the RFID rings on the nozzles can crack when the nozzle is dropped onto the pavement, and they also can crack at low ambient temperatures, which increases maintenance problems in colder climates. Furthermore, installation of the equipment on the vehicle remains just as difficult.

In light of the above, an opportunity arises to provide an improved system for controlling the dispensing of fuel to authorized vehicles.

### SUMMARY

Roughly described, a fueling control system includes a nozzle module for use with a particular fuel dispensing nozzle, a vehicle module for use with a particular fuel tank inlet, and a site controller. The nozzle module, in response to predefined user activation behavior such as removal of the nozzle from an on-hook position and insertion into the inlet of a fuel tank, awakens from a low power mode to an active mode, and wirelessly transmits a wake-up signal and an identification of the particular nozzle. The vehicle module, in response to detection of the wake-up signal, awakens from a low power mode to an active mode, detects the transmitted nozzle identification, and wirelessly requests authorization for the particular nozzle to dispense fuel. The site controller, in response to detection of the nozzle identification, authorizes dispensing of fuel through the particular nozzle.

The above summary is provided in order to convey a basic understanding of some aspects of the invention. The summary is not intended to identify key or critical elements of the invention or to delineate the scope of the invention. Its sole purpose is to present some concepts of the invention in a simplified form as a prelude to the more detailed description that is presented later. Particular aspects of the invention are described in the claims, specification and drawings.

### BRIEF DESCRIPTION OF THE DRAWINGS

The invention will be described with respect to particular embodiments thereof, and reference will be made to the drawings, in which:

FIG. 1 illustrates a refueling station 100 that incorporates features of the invention.

FIG. 2 is a schematic drawing illustrating interconnections among some components of FIG. 1.

FIG. 3 is a drawing of a nozzle, mounted in its “on-hook” position.

FIG. 4 is a drawing of the fuel inlet area of a vehicle.

FIG. 5 is a flow diagram for illustrating the overall operation of the system.

FIG. 6 is a diagram of a protocol by which a vehicle module requests authorization for a particular nozzle to dispense fuel.

FIG. 7 is a block diagram of a nozzle module.

FIG. 8 is a schematic diagram of parts of the nozzle module 314, showing particular detail in the power control section of FIG. 7.

FIG. 9 illustrates a nozzle as inserted into the inlet of a vehicle fuel tank.

FIG. 10 is a flow chart of functions performed by the nozzle module of FIG. 7.

FIG. 11 is a block diagram of a vehicle module.

FIG. 12 is a flow chart of functions performed by the vehicle module of FIG. 11.

FIG. 13 is a flow chart of functions performed by the site controller of FIG. 2.

FIG. 14 is a schematic diagram of parts of the vehicle module 414, showing particular detail in the power control section of FIG. 11.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

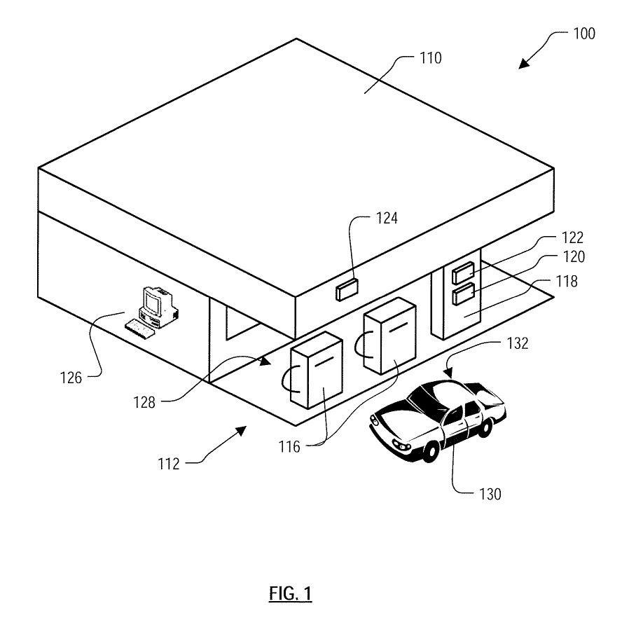

FIG. 1 illustrates a refueling station 100 that incorporates features of the invention. It comprises an administration building 110 and one or more fuel islands 112 (only one of which is shown). Two fuel dispensers 116 are located on the fuel island 112. While the fuel dispensed by these dispensers is gasoline, it will be appreciated that in other embodiments the fuel can be diesel, propane, CNG, etc. A pillar 118 is also located on the fuel island 112, on which is mounted an individual polling unit 120 for the fuel island 112, and a fuel island controller 122. A master interrogator 124 is located within wireless communication distance with all the fuel islands, and a site computer 126, which may be a conventional personal computer programmed as described herein, is housed in the administration building 110. Each dispenser 116 includes one or more fuel nozzles 128 (only one of which is shown on each dispenser), and on each such nozzle is mounted a respective nozzle module (not shown in FIG. 1). A vehicle 130 is shown parked at one of the dispensers 116, ready for fueling. The vehicle 130 has a fuel tank inlet 132 on the side of the vehicle facing the dispenser 116. (As used herein, the terms “fueling” and “refueling” are interchangeable.)

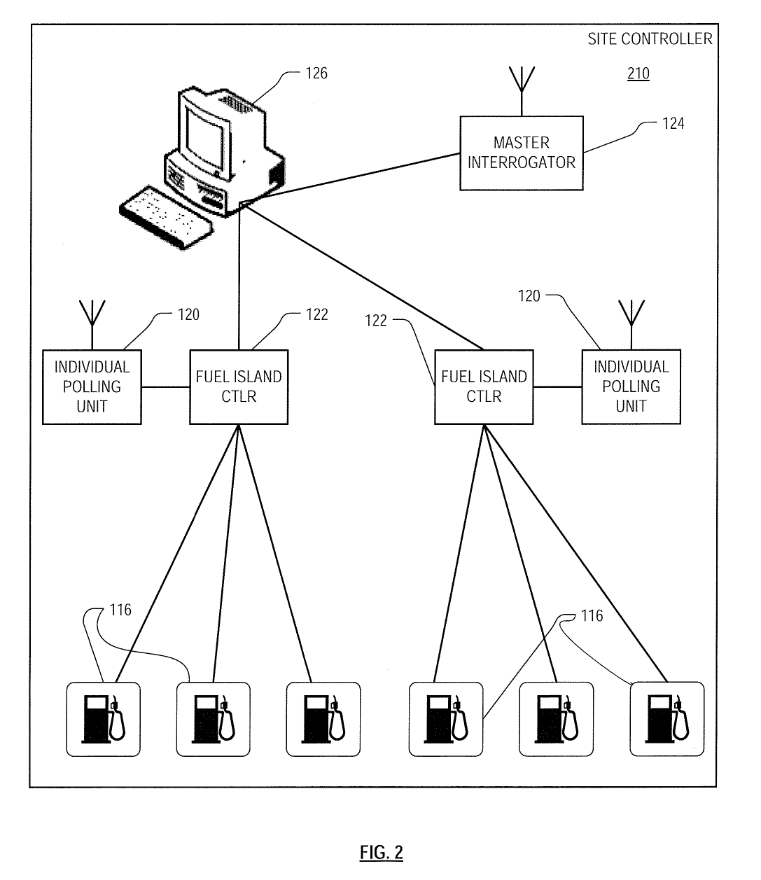

The site computer 126, the master interrogator 124, the fuel island controllers 122 and the individual polling units 120 all operate cooperatively to perform the functions described herein for controlling the dispensing of fuel from the dispensers 116. Collectively they are referred to herein as the site controller 210. Some of these components also perform other functions not related to the present discussion. FIG. 2 is a schematic drawing illustrating some of interconnections among these components. As shown, the site computer 126 is connected to the master interrogator 124 and to each of the fuel island controllers 122. Each of the fuel island controllers 122 is in turn connected to all of the fuel dispensers 116 on its fuel island, and to one of the individual polling units 120. In operation, the master interrogator 124 and the individual polling units 120 are involved in communicating wirelessly with the vehicle modules as described hereinafter. When the site computer 126 authorizes the dispensing of fuel through a particular nozzle 128, it so notifies the appropriate fuel island controller 122, which in turn authorizes the appropriate dispenser 116 to turn on appropriate nozzle 128.

The particular arrangement of components shown in FIG. 2 depict only one arrangement of equipment for performing the functions described herein for controlling the dispensing of fuel at the site 100. Numerous other arrangements and divisions of functions among components are possible as well. The term “site controller” is intended herein to encompass whatever equipment is involved in a particular installation for performing the functions described herein for the site controller. It is to be noted that in some installations, one or more of the components may be located off-premises. Additionally, although the fueling site of FIG. 1 itself is shown as a stationary building, in another embodiment it can be mobile, and installed for example on a fuel tanker truck.

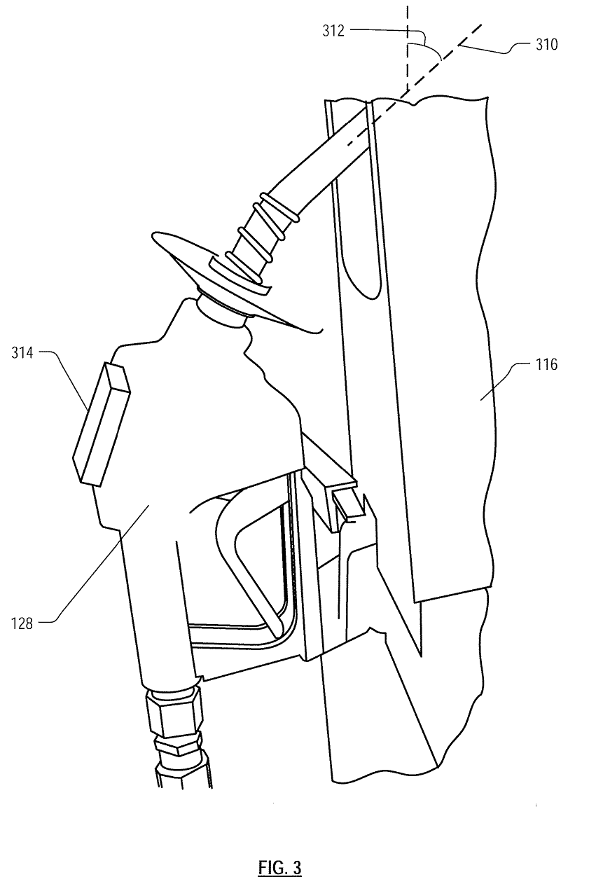

FIG. 3 is a drawing of one of the nozzles 128, mounted in its “on-hook” position on one of the dispensers 116. The “on-hook” position as used herein means its position when stowed, and in some installations it might be on a hook, for example, rather than on a dispenser. The nozzle has an angle when on-hook, which may be defined by any of a number of reference surfaces or features on the nozzle. For convenience, as used herein, the “angle” of a nozzle at any point in time is the angle of its centerline at the longitudinal flow position where fuel exits the nozzle, measured relative to the vertical. In the view of FIG. 3, the centerline is denoted 310, and the angle it makes with the vertical is denoted 312.

Mounted on the nozzle handle is a nozzle module 314, described in more detail hereinafter. Preferably it is protected by a rubber boot that encases the nozzle handle, but that is not required in all embodiments. If provided, the boot preferably includes a recess specifically to accommodate the nozzle module 314. The presence of the nozzle module 314 therefore is not hidden from maintenance personnel, and so is less likely to be neglected after repair or replacement of the nozzle 128. Additionally, the rubber of the boot is preferably flexible enough that the absence of a nozzle module inside the boot can be easily noticed because the boot will look limp.

The nozzle module 314 preferably uses a tilt switch to trigger activation as described hereinafter, but if a different activation trigger is provided, then the nozzle module 314 can be located somewhere else instead of on the nozzle. The nozzle module 314 is located at the fueling site rather than on the vehicle, and each nozzle module 314 is associated with a particular corresponding fueling nozzle. In an installation in which nozzles are not enabled individually, then each nozzle module 314 can be associated with a corresponding group of fueling nozzles 128 that are enabled together.

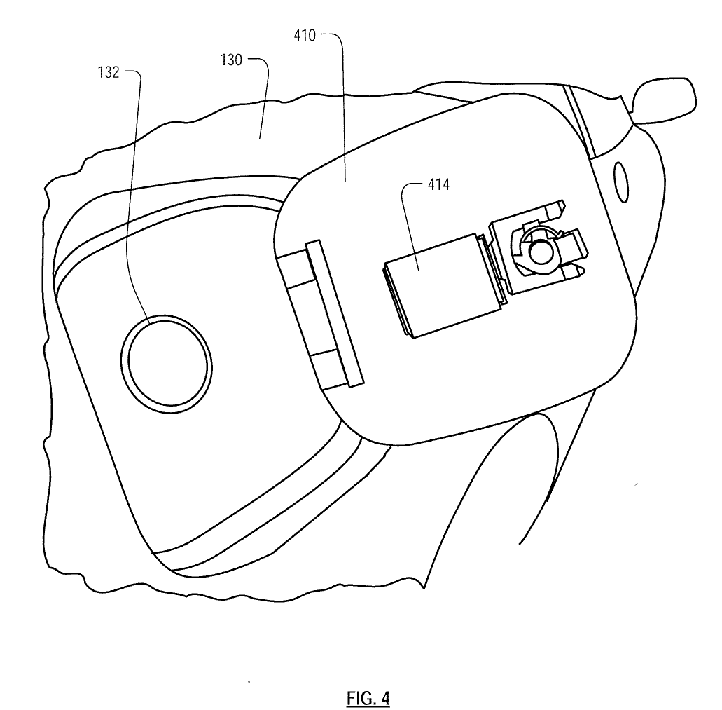

FIG. 4 is a drawing of the fuel inlet area of the vehicle 130. On the example vehicle shown, the fuel inlet 132 is protected by a fuel door 410, shown in the figure in its open position. Mounted near the fuel inlet 132, on the inside of the fuel door 410 in the example shown, is a vehicle module 414, described in more detail hereinafter. Note that the system described herein can also be used to fuel standalone fuel tanks, which need not necessarily be associated with vehicles. In such a case the vehicle module 414 can be mounted on the fuel tank near its fuel inlet, or can even be carried separately by the user and brought into proximity with the nozzle module 314 from which fuel is desired.

Both the nozzle module 314 and the vehicle module 414 are battery operated, and both communicate with other components of the system wirelessly. Thus neither needs be wired to any other component, thereby greatly simplifying installation and maintenance.

### Overall System Operation

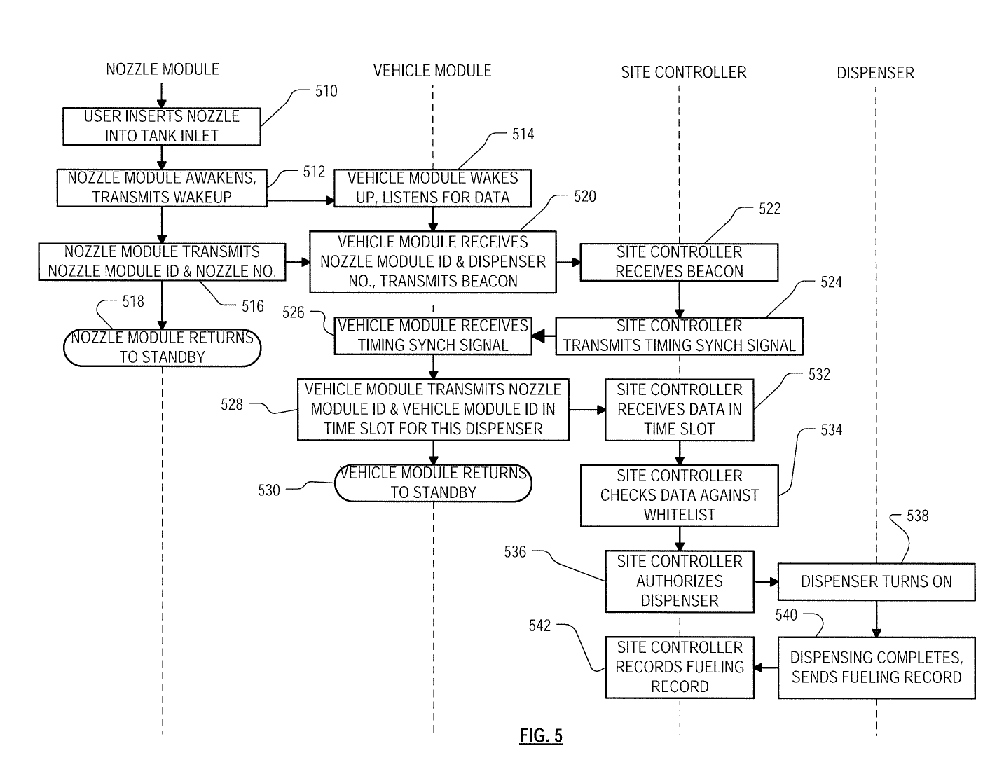

FIG. 5 is a flow diagram which illustrates the overall operation of the system. Four main components are involved in the operation: the nozzle module 314 for the nozzle associated with the dispenser from which the user desires fuel; the vehicle module 414 on the vehicle or fuel tank into which the fuel is to be dispensed; the site controller 210; and the dispenser 116. It is to be noted that some of the functions ascribed herein to the dispenser 116 might actually be performed by the fuel island controller 122, so as used herein, the term “dispenser” is considered to include those portions of other components not physically on the pump itself that are involved in the performance of such functions.

Referring to FIG. 5, both the nozzle module 314 and the vehicle module 316 begin in standby modes. In this mode both modules draw very little power if any from their respective batteries, thereby preserving battery life.

In step 510, the user inserts the nozzle 128 into the tank inlet. By means described below, this action causes the nozzle module 314 to awaken and to transmit a wake-up signal wirelessly to the vehicle module 414 (step 512). In step 514, the vehicle module 414 awakens and listens for data from the nozzle module 314. In one embodiment, the data is sent separately and subsequently to the wake-up signal. In a preferred embodiment, however, the data is sent as part of the wake-up signal, and is repeated a number of times to permit the vehicle module 414 sufficient time to awaken and decode it. In FIG. 5 the data is shown transmitted by the nozzle module 314 separately from the wake-up signal, in step 516, but it will be understood that step 516 may simply be a re-transmission of the wake-up signal transmitted in step 512. After transmitting the data, in step 518, the nozzle module 314 returns promptly to standby mode without transmitting anything further. The entire operation of the nozzle module 314 can complete in only a few seconds, thereby minimizing the draw of power from the battery.

Note that the communication between the nozzle module 314 and the vehicle module 414 is unidirectional. No acknowledgement signal, for example, is transmitted from the vehicle module 414 back to the nozzle module 314 to indicate either that it has awaken and is ready to receive data, or that it has successfully received data. While either or both of such acknowledgment signals can be included in a different embodiment, their absence in the embodiment of FIG. 5 permits a simpler and less costly design of the nozzle module 314 since it does not require any components for receiving and decoding any incoming radio signals. The vehicle module 414 can also be made simpler and less costly, since the transceiver used for communicating with the site controller 210 differs from the one used for communicating with the nozzle module 314, and the latter can be a receiver only.

While an acknowledgement for handshaking between the two modules could be implemented in order to notify the nozzle module 314 to re-transmit should the vehicle module 414 fail to awaken after the first transmission, the first transmission tends to succeed the vast majority of times. Additionally, since the data transmitted by the nozzle module 314 in step 516 is the same as the wake-up signal transmitted in step 512 in the present embodiment, the second transmission of this signal in step 516 can awaken the vehicle module 414 should the first transmission fail to do so. In that case the vehicle module 414 will obtain the data from the third transmission of the wake-up/data signal. Still further, if all the wake-up/data signal transmissions from the nozzle module 314 fail to awaken the vehicle module 414, then the nozzle will not dispense fuel and the user will intuitively remove the nozzle from the fuel tank inlet, tilting it up to approximately its on-hook position before re-inserting it into the inlet. This will reset the nozzle module 314 and cause it to transmit the wake-up/data signal again.

The data sent by the nozzle module 314 includes an identification of the nozzle with which it is associated (for example a number ranging from 1-16). Preferably it also includes an identification of the nozzle module 314 itself, though some embodiments can omit that feature. The data is received by the vehicle module 414 in step 520, and in response to receiving the data, it transmits a beacon signal to the site controller 210. The beacon signal is received by the site controller 210 in step 522. The beacon signal is the same signal as is sent by all vehicle modules after receipt of data from a nozzle module 314, and serves the function of notifying the site controller 210 that at least one vehicle module at the site is ready to transmit data to the site controller 210. The beacon signal does not indicate which vehicle module is ready to transmit.

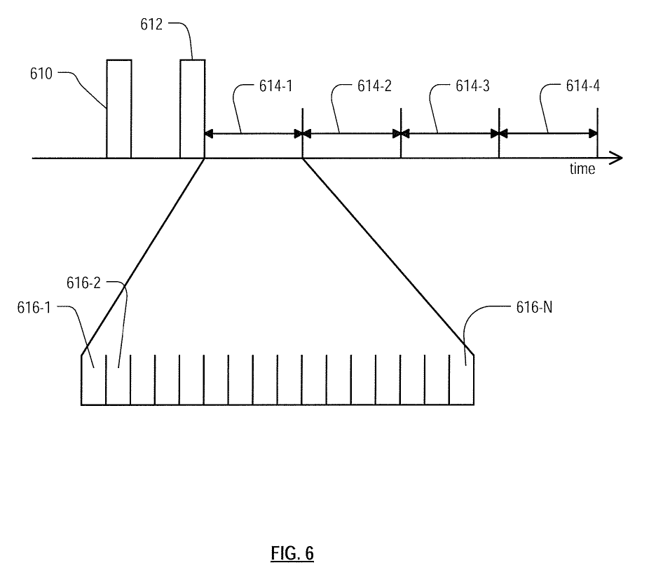

FIG. 6 is a diagram of the protocol according to which the vehicle modules 414 transmit data to the site controller to request authorization for a particular nozzle to dispense fuel. During time 610, the site controller 210 detects the beacon signal. In response thereto, during time 612, the site controller 210 transmits a synchronization signal, which indicates to all the vehicle modules 414 the start of M repetitions (cycles) 614-1 through 614-M (collectively 614) of a sequence of N time slots each. The diagram shows an exploded view of one cycle 614-1 for illustrating the time slots 616-1 through 616-N (collectively 616). Thus, each of the N time slots repeats M times. In an embodiment, M can be 4 and N can be 16. Each time slot occupies, for example, on the order of 75-100 ms. Each time slot in a given cycle is allocated to a respective one of the nozzles 128; thus, the system can accommodate up to N nozzles 128. Stated another way, each nozzle 128 (or group of nozzles, if they are to be authorized only as a group) that is present and available for dispensing fuel at the site, has an associated and dedicated one of the time slots 616 allocated to it.

Returning to FIG. 5, therefore, after the site controller 210 detects the beacon signal in step 522, it wirelessly transmits the timing synchronization signal 612 (step 524). The vehicle module 414 detects the timing synchronization signal in step 526, and in response thereto, in step 528, it transmits its data during each repetition of the time slot associated with the nozzle ID that it received from the nozzle module 314 in step 420. The vehicle module 414 then returns to standby mode without making any further transmissions (step 530), again minimizing battery usage. The data sent by the vehicle module 414 is received by the site controller 210 in step 532, and from the number of the time slot in which the data was received, the site controller 210 knows which nozzle is the subject of the authorization request.

Preferably the data transmitted by the vehicle module 414 in step 528 includes the nozzle module ID which the vehicle module 414 had received from the nozzle module 314 in step 520, and in step 534, the site controller 210 checks the nozzle module ID against a whitelist database. Preferably the data also includes an identification of the vehicle module 414 as well, and the site controller 210 also checks the vehicle module ID against a whitelist database in step 534. As used herein, the whitelist checks in step 534 are said to “verify the authority” of the nozzle module 314 to authorize the dispensing of fuel through its associated nozzle 128, and to “verify the authority” of vehicle module 414 to authorize the dispensing of fuel into its associated fuel tank inlet 132. Verification of authority, as used herein, is different from merely verifying the module ID, which could mean checking merely that it is the module that is attached to the particular nozzle. Additionally, whereas the site controller in step 534 verifies the authority of modules 314 and 414 to authorize the dispensing of fuel by comparing their IDs to respective whitelists, it will be understood that numerous other verification mechanisms can be used instead in different embodiments. For example, the IDs could be checked against blacklists, or even merely verified against some mathematical ID validity criteria. Other variations will be apparent to the reader.

In step 536, assuming authority has been verified in step 534, the site controller 210 signals the dispenser for nozzle 128 to turn on the nozzle (or group of nozzles) associated with the time slot 616 in which the data was received in step 532. This authorization is typically performed via a wired connection from the site computer 126 to the appropriate fuel island controller 122, but could be performed wirelessly in a different embodiment. In step 532 the dispenser turns on. When dispensing completes, typically indicated by return of the nozzle 128 to the on-hook position, this is sensed by the dispenser 116. In step 540, the dispenser transmits a fueling record to the site controller 210. The site controller receives it in step 542 and records it in a database.

### Nozzle Module

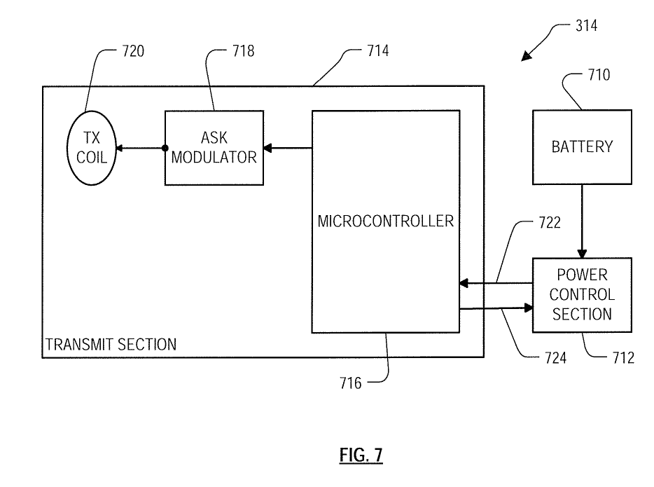

FIG. 7 is a block diagram of an embodiment of the nozzle module 314. It includes a battery 710 connected to a power control section 712, which forwards power to a transmit section 714 via a power line 722. The battery 710 is dedicated to the nozzle module 314 and avoids any need for a wired connection to an external power source. The transmit section 714 includes a microcontroller 716 having one output that drives an Amplitude Shift Keying (ASK) modulator 718, the output of which drives a transmit coil 720. The microcontroller 716 also has a shut-down output 724 by which it signals the power control section 712 to return the nozzle module 314 to standby mode. As mentioned, the nozzle module 314 remains in a low power standby mode until it is awakened by some predefined user behavior, after which it transmit its data (steps 512 and 516) and returns to standby mode. Since the functions of the nozzle module 314 do not include receiving any transmission from outside the nozzle module 314, it has no receiver section. (In an embodiment a receiver section can be provided but not used.)

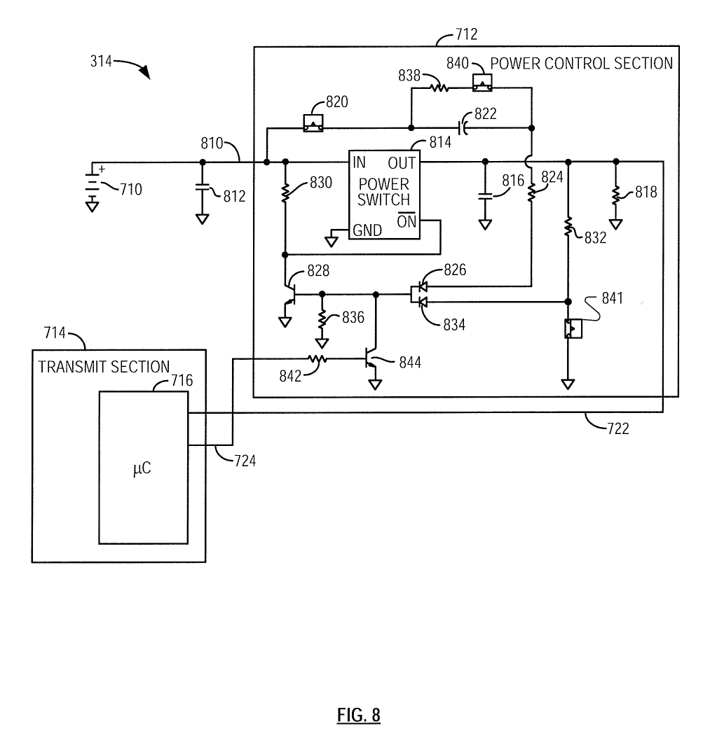

FIG. 8 is a schematic diagram of parts of the nozzle module 314, showing particular detail in the power control section 712. The power control section 712 has a battery power input 810 connected to the battery 710, which is bypassed by a bypass capacitor 812. The battery power input 810 is connected to the power input terminal of a power switch 814, which may for example be a model MAX891L available from Maxim Integrated Products, Sunnyvale, Calif. The power output terminal of the power switch 814 is bypassed to ground by a capacitor 816 and also by a resistor 818, and forms the power output lead 722 of the power control section 712.

The battery power input 810 of the power control section 712 is also connected via a first tilt switch 820 to one terminal of a capacitor 822, the other terminal of which is connected via a resistor 824 to the anode of a diode 826. The cathode of the diode 826 is connected to the base of an NPN transistor 828. The emitter of transistor 828 is connected to ground, and the collector is connected through a pull-up resistor 830 to the battery power input 810. The collector of transistor 828 is also connected to an active low control (ON-/OFF) input of the power switch 814. Power switch 814 also has a ground terminal connected to ground.

The power output lead 722 is also connected via a resistor 832 to the anode of a second diode 834, the cathode of which is connected to the base of transistor 828. The base of transistor 828 is also connected through a pull-down resistor 836 to ground. In addition, the series combination of a resistor 838 and a second tilt switch 840 is connected across capacitor 822. A third tilt switch 841 is connected between ground and the junction between resistor 832 and the anode of diode 834.

The shut-down output 724 of the transmit section 714 is connected via a resistor 842 to the base of an NPN transistor 844, the emitter of which is connected to ground and the collector of which is connected to the base of transistor 828.

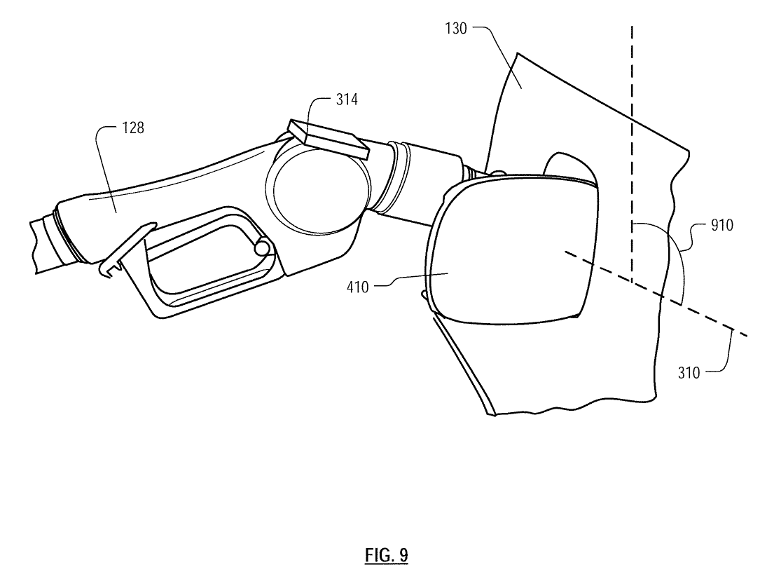

Tilt switch 820 senses the angle of the board on which it is mounted, and hence senses the angle of the nozzle 128. When the nozzle 128 is in its on-hook position as shown in FIG. 3, and the nozzle 128 makes an angle 312 with the vertical (FIG. 3), tilt switch 820 is open (non-conducting). FIG. 9 illustrates the nozzle 128 as inserted into the inlet 132 of the fuel tank of vehicle 130. In this position, the nozzle makes an angle 910 with the vertical, which is on the order of 60 degrees greater than the angle 312. There is another position (not shown) in which the nozzle is often used, for example where the nozzle is inserted into the fuel tank for a generator on a truck. That angle is approximately 90 degrees greater than the angle 312. It is desired that the nozzle module transmitter section 714 turn on when the user tilts the nozzle for inserting into fuel inlet of either a vehicle or a generator tank, so the tilt switch 820 is designed to close (conduct) when the nozzle tilt reaches some angle which is sufficiently greater than the on-hook nozzle angle 312 to avoid triggering by accident, yet not so great that it exceeds the normal angle of the nozzle when inserted into the fuel inlet. Any angle greater than approximately 45 degrees would be appropriate for this purpose, and in the embodiment of FIG. 8, the tilt switch 820 is designed to close when the nozzle tilt angle exceeds the on-hook nozzle angle 312 by about 60 degrees. It is also desirable that the nozzle module transmitter section 714 not be triggered if the nozzle tilt exceeds about 90 degrees more than the on-hook tilt angle 312, because that angle also indicates that the nozzle is not being used for fueling and should not be turned on. Thus tilt switch 820 is also designed to open when the nozzle tilt angle exceeds the on-hook nozzle angle 312 by about 90 degrees. Tilt switches which can be ordered to operate at the angles described herein include the SQ-SEN-390 series available from SignalQuest, Inc., Lebanon, N.H. Tilt switches 840 and 841 are both designed to switch at the same tilt angles as switch 820, but in a complimentary manner. That is, tilt switches 840 and 841 close when tilt switch 820 opens, and open when tilt switch 820 closes.

In operation, when the nozzle 128 is on-hook, tilt switch 820 is open, tilt switch 841 is closed, and power switch 814 is off. Thus no current flows into the base of transistor 828 through either of the diodes 826 and 834, and pull-up resistor 830 pulls the voltage on the control input of power switch 814 up to its inactive level. Power switch 814 therefore remains off, and no power is supplied on line 722 to the transmit section 714. When the nozzle 128 is removed and tilted for inserting into a fuel tank inlet, tilt switch 820 closes and tilt switches 840 and 841 open. Battery current therefore flows through the tilt switch 820, capacitor 822, resistor 824 and diode 826 to the base of transistor 828, which pulls down the control input of power switch 814 to its active level, transferring power onto the power supply line 722 to the transmit section 714. Capacitor 822 eventually charges and current ceases to flow through it to the base of transistor 828, but power switch 814 is latched in its on mode since current is flowing from the power lead 722 through resistor 832 and diode 834 into the base of transistor 828. Tilt switch 841 is open when the nozzle is in the fueling position, so it does not divert any of the current flowing through resistor 832.

After the transmit section 714 completes its work it asserts the shut-down signal on line 724, causing transistor 844 to pull down the voltage on the base of transistor 828. This turns off transistor 828, which “breaks the latching circuit” by allowing the voltage on the control input of power switch 814 to rise to the inactive level and turning it off. Thus battery power is prevented from reaching the power output lead 722 and transmit section 714 shuts down.

At some further time, the nozzle 128 is removed from the fuel tank inlet and replaced on-hook. This causes tilt switch 840 to close, thereby discharging capacitor 822 in preparation for the next activation. It also causes tilt switch 820 to open, thereby preventing any conduction of battery power through the tilt switch 840 or the newly discharged capacitor 822 from re-triggering the power switch 814 to turn on. It also causes tilt switch 841 to close, once again ensuring that the latching circuit remains broken. The nozzle module 314 remains in this low power mode until the nozzle 128 is again removed from the on-hook position and tilted to insert into a fuel tank inlet.

Note that the microcomputer 716 in the transmit section 714 is also programmed with a watchdog timer that automatically asserts the shut-down signal on line 724 after a predetermined number of seconds, should the microcomputer 716 fail for some reason to do so in the normal course.

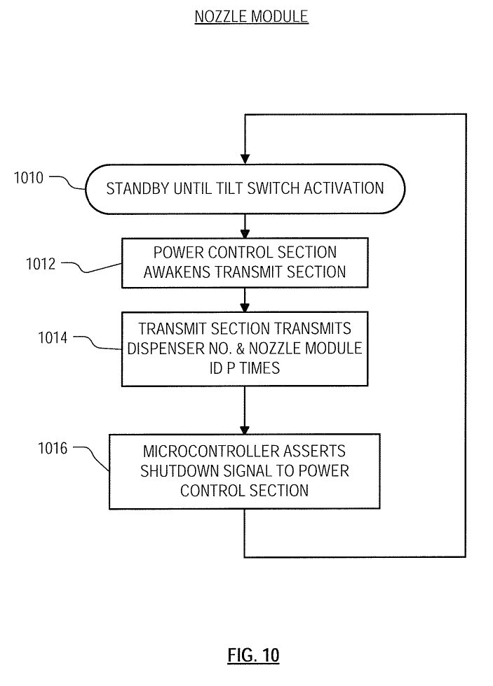

With the above discussion as a foundation, FIG. 10 is a flow chart of the main functions performed by the nozzle module 314. As with all flowcharts herein, it will be appreciated that many of the steps can be combined, performed in parallel or performed in a different sequence without affecting the functions achieved. In some cases a re-arrangement of steps will achieve the same results only if certain other changes are made as well, and in other cases a re-arrangement of steps will achieve the same results only if certain conditions are satisfied. In step 1010, the nozzle module 314 is in standby mode. Standby mode is a low power mode which draws significantly less power from the battery 710 than active mode. Upon tilt switch activation, in step 1012, the power control section awakens the transmit section 714 to its active mode, as described above with respect to FIG. 8. The transmit section 714 in step 1014 then transmits the nozzle number and nozzle module ID as programmed into the nozzle module 314 previously, some number of times P, as described above with respect to FIG. 5. P may be four, for example. Then, in step 1016, the transmit section 714 asserts the shut-down signal on line 724, to cause the nozzle module 314 to return to standby mode (step 1010).

Note that while tilt switch activation as described herein is preferred for triggering activation of the nozzle module 314, other mechanisms can be used instead in different embodiments. For example, the tilt switch can be replaced by an accelerometer, or by a vehicle proximity detector for detecting arrival of the vehicle to be fueled, or even by a manually operated push-button if desired.

### Vehicle Module

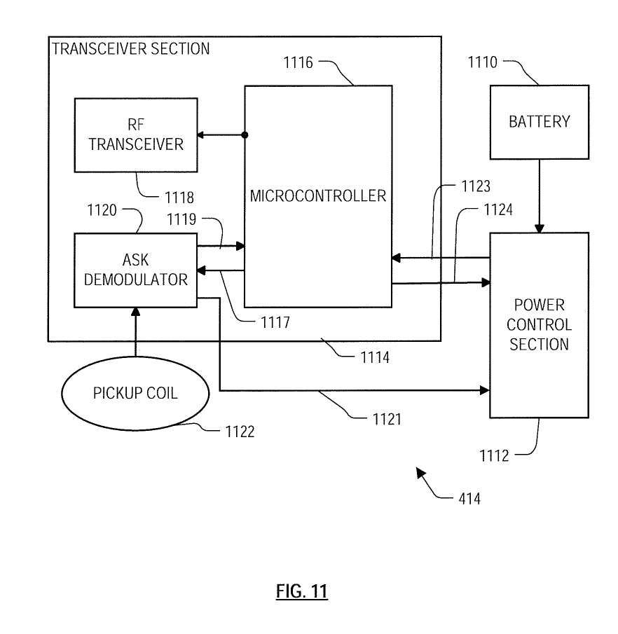

FIG. 11 is a block diagram of the vehicle module 414. Like the nozzle module 314, vehicle module 414 includes a battery 1110 supplying power to a power control section 1112 which, when the vehicle module 414 is not in standby mode, supplies the power to a transceiver section 1114 via power line 1123. The battery 1110 is dedicated to the vehicle module 414 and avoids any need for a wired connection to the vehicle's power system. The transceiver section 1114 in the vehicle module 414 includes a microcontroller 1116 in communication with an RF transceiver 1118 for communicating wirelessly with the site controller 210. The RF transceiver 1118 transmits with a range of at least about 50 feet, since it must reach all the way to the master interrogator 124. This is as distinguished from the ASK transmitter in the nozzle module 314, whose range is limited to about 18 inches, in order to avoid awakening the vehicle module of a different vehicle that might be parked at an adjacent dispenser. The transceiver section 1114 also includes an ASK demodulator 1120 connected to a pickup coil 1122, for recovering the data transmitted by the nozzle module 314. The ASK demodulator 1120 also has an output 1121 connected to the power control section 1112 to provide the wake-up signal, and another output 1119 to provide received data to the microcontroller 1116. Like the nozzle module 314, the microcontroller 1116 also has a shut-down output 1124 connected to the power control section 1112 to signal the latter to return the vehicle module 414 to standby mode when its operation is complete. Microcontroller 1116 also has a demodulator reset output 1117 connected to the ASK demodulator 1120, by which it resets the demodulator 1120 at the same time it signals the power control section 1112 to return to standby mode.

The power control section 1112 is similar to the power control section 712 in the nozzle module 314, with a power switch in a latching circuit that latches power on to the transceiver section 1114 until the transceiver section 1114 asserts a shut-down signal, which operates to break the latching circuit. One significant difference is that the power control section 1112 is triggered to its active mode by an appropriate signal (the wake-up signal from the nozzle module 314) received by the pickup coil 1122, rather than by a tilt switch.

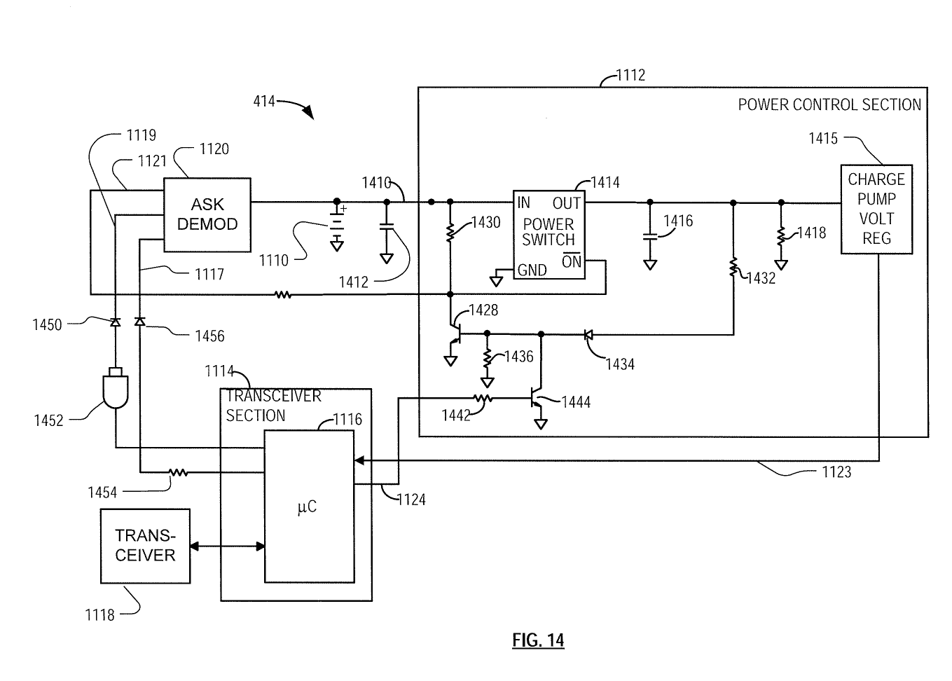

FIG. 14 is a schematic diagram of parts of the vehicle module 414, showing particular detail in the power control section 1112 (FIG. 11). The power control section 1112 has a battery power line input 1410 connected to the battery 1110, which is bypassed by a bypass capacitor 1412. The battery power input 1410 is connected to the power input terminal of a power switch 1414, which as for the nozzle module, may for example be a model MAX891L from Maxim Integrated Products. The power output terminal of the power switch 1414 is bypassed to ground by a capacitor 1416 and also by a resistor 1418, and is then provided to the input of a step-up voltage regulator 1415. The output of regulator 1415 forms the power output lead 1123 of the power control section 1112.

The battery power input 1410 of the power control section 1112 is also connected to the power supply input of ASK demodulator 1120. ASK demodulator 1121 has a wakeup signal output 1121 connected via a resistor to the collector of an NPN transistor 1428. The collector of the transistor 1428 is also connected through a pull-up resistor 1430 to the battery power input 1410, and the emitter of transistor 1428 is connected to ground. The collector of transistor 1428 is also connected to an active low control (ON-/OFF) input of the power switch 1414. Power switch 1414 also has a ground terminal connected to ground.

The power output lead of the power switch 1414 is also connected via a resistor 1432 to the anode of a diode 1434, the cathode of which is connected to the base of transistor 1428. The base of transistor 1428 is also connected through a pull-down resistor 1436 to ground. The shut-down output 1124 of the transceiver section 1114 is connected via a resistor 1442 to the base of an NPN transistor 1444, the emitter of which is connected to ground and the collector of which is connected to the base of transistor 1428.

The data output of ASK demodulator 1120 is connected to the cathode of a diode 1450, the anode of which is connected to the input of a buffer 1452. The output of buffer 1452 is connected to an I/O pin of microcomputer 1116. The microcomputer 1116 also has an I/O pin connected through a resistor 1454 to the anode of a diode 1456, the cathode of which is connected to a reset input of ASK demodulator 1120.

In operation, in standby mode, power switch 1414 is off. Thus no current flows into the base of transistor 1428 through diode 1434, and pull-up resistor 1430 pulls the voltage on the control input of power switch 1414 up to its inactive level. Also since ASK demodulator 1120 senses no signal, it does not drive its wakeup output 1121, thereby allowing the resistor 1430 to pull up the voltage on the control input of power switch 1414. Power switch 1414 therefore remains off, and no power is supplied on line 1123 to the transceiver section 1114. When ASK demodulator 1120 senses a signal on the pickup coil 1122, it drives wakeup signal 1121 low, thereby pulling down the voltage on the control input of power switch 1414 to its active level. The power switch 1414 therefore transfers battery current to the charge pump 1415, which in turn powers transceiver section 1114 via power line 1123. Power switch 1414 is also latched in its on mode since current is flowing from the its power out lead through resistor 1432 and diode 1434 into the base of transistor 1428. This reinforces the pull-down of the voltage on the control input of power switch 1414, regardless of whether ASK demodulator 1120 ceases asserting its wakeup output signal on line 1121. Further data demodulated by the ASK demodulator 1120 during this time is transmitted via diode 1450 and buffer 1452 to the microcomputer 1116 for processing.

After the transceiver section 1114 completes its work it asserts the reset signal online 1117 causing the ASK demodulator to cease detecting incoming signals and stop asserting the wakeup signal on line 1121. The transceiver section 1114 also asserts the shut-down signal on line 1124, causing transistor 1444 to pull down the voltage on the base of transistor 1428. This turns off transistor 1428, which “breaks the latching circuit” by allowing the voltage on the control input of power switch 1414 to rise to the inactive level and turning it off. Thus battery power is prevented from reaching the power output lead 1123 and transceiver section 1114 shuts down. As in the nozzle module 314, the microcomputer 1116 in the transceiver section 1114 is also programmed with a watchdog timer that automatically asserts the reset signal on line 1117 and the shut-down signal on line 1124 after a predetermined number of seconds, should the microcomputer 1116 fail for some reason to do so in the normal course.

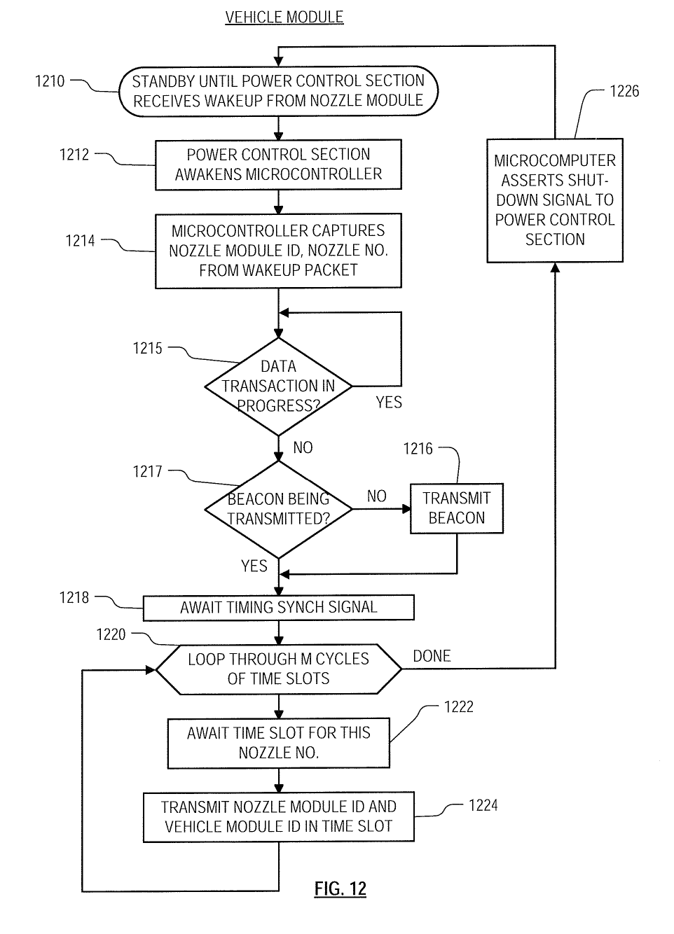

FIG. 12 is a flow chart of the main functions performed by the vehicle module 414. In step 1210, the vehicle module 414 is in standby mode. As for the nozzle module 314, standby mode for the vehicle module 414 is a low power mode which draws significantly less power from the battery 1110 than active mode. Upon receipt of a wake-up signal from the nozzle module 314, in step 1212 the power control section 1112 in the vehicle module 414 awakens the microcontroller 1116 by supplying power to it. In step 1214, the microcontroller 1116 captures the nozzle module ID and the nozzle number from the second or subsequent transmission of the wake-up packet. Then, in step 1215, the transceiver section 1114 listens to determine whether a data transaction is already in progress from another vehicle module. If so, then transceiver section 1114 backs off and waits for the full M cycles to complete. Thereafter, or if there is no ongoing data transaction already in progress, then in step 1217 the transceiver section 1114 listens for whether another vehicle module is already transmitting the beacon signal. If it is, then there is no need for transceiver section 1114 to do so as well. If not, then in step 1216, the transceiver section 1114 transmits the beacon signal to the site controller, via the RF transceiver 1118. In step 1218 the transceiver section 1114 awaits receipt of the timing synchronization signal via the RF transceiver 1118, and in step 1220 the microcontroller 1116 begins a loop through M cycles 614 of time slots 616, where M is prescribed by the transmission protocol discussed above with respect to FIG. 6. During the first cycle, in step 1222, the microcontroller 1116 awaits the time slot 616 corresponding to the nozzle number received from the nozzle module 314 in step 1214. When it arrives, in step 1224, microcontroller 1116 transmits the nozzle module ID and the ID of the vehicle module 414, during that time slot. The microcontroller 1116 then returns to step 1220 to repeat the transmission during the same time slot 616 in the next cycle 614 of time slots. After all M cycles have been completed, the microcontroller asserts the shut-down signal to the power control section 1112 (step 1226), and the vehicle module 414 returns to standby mode in step 1210.

Both microcontrollers 716 and 1116 are integrated circuits that include a processor, a ROM that has been pre-programmed with processor instructions for performing the functions described herein, a memory for temporary storage of data and instructions during operation of the program, and I/O circuits for communication with external devices such as the power control circuits 712 and 1112, the ASK modulator 718 in the nozzle module 314, and the ASK demodulator 1120 and the RF transceiver 1118 in the vehicle module 414.

### Site Controller

The site controller 210, in the present embodiment, contains the components set forth above with respect to FIG. 2. The site computer 126 itself typically includes a processor and peripheral devices such as memory and a file storage subsystem. Typically it also includes user interface input and output devices such as keyboard and mouse, and monitor. Typically it also includes a network interface for communicating with other devices both on-site and off-site. The file storage subsystem can include one or more hard disk drives and/or optical disk drives, which collectively store the basic programming and data constructs that provide the functionality of the computer 126 as described herein. Software modules stored in the file storage subsystem are generally executed by processor to perform the functions described herein. The whitelist databases are also stored in the file storage subsystem and referenced by the processor, under control of the software, during performance of the functions described herein. As used herein, the term “database” does not necessarily imply any unity of structure. For example, two or more separate databases, when considered together, still constitute a “database” as that term is used herein. Note that computer system 126 itself can be of varying types including a personal computer, a portable computer, a workstation, a mainframe, or any other data processing system in various embodiments. Due to the ever changing nature of computers and networks, the description herein of computer system 126 is intended only as a specific example for purposes of illustrating preferred embodiments of the invention. Many other configurations of computer system 126 are possible.

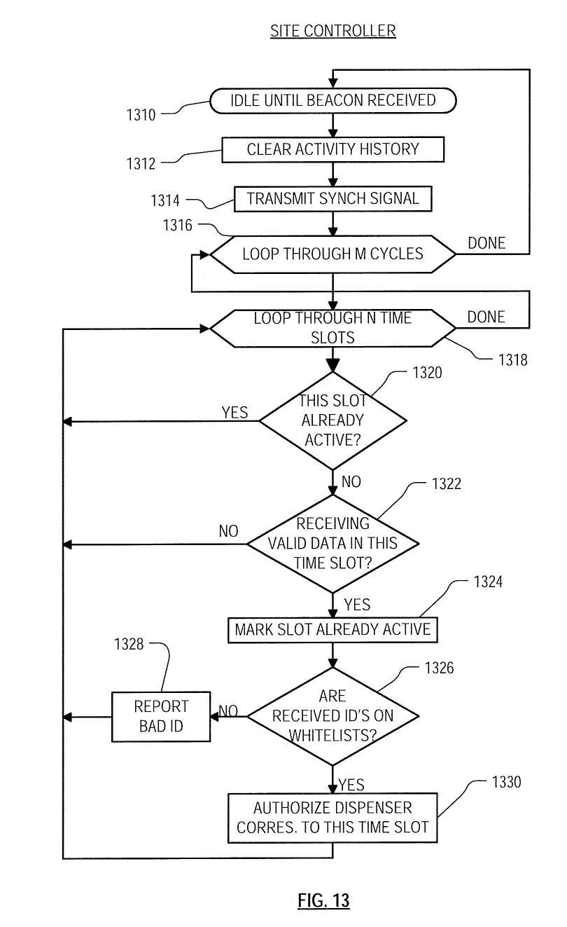

FIG. 13 is a flow chart of the main functions performed by the site controller 210. In step 1310, the site controller 210 idles, or performs other functions not important for an understanding of the invention, until the beacon signal is received. In step 1312, an activity history of recent requests for authorization of the various dispenser nozzles, is cleared. In step 1314, the detection of the beacon in step 1310 causes the site controller 210 to transmit the timing synchronization signal 612 (FIG. 6). Then the site controller 210 begins a loop 1316 through the M cycles 614 of time slots 616. During each cycle 614 of time slots 616, site controller 210 begins another loop 1318, nested within loop 1316, through the N time slots 616 in the current cycle 614. In step 1320, site controller 210 first checks the activity history to determine whether the nozzle 128 corresponding to the current time slot 616 has already been the subject of an authorization request during a previous cycle 614 (since the most recent beacon receipt in step 1310). If it has, then site controller 210 simply returns to loop 1318, thereby ignoring any transmission during the current slot 616. The processing of an authorization request can occupy a significant amount of time relative to the duration of a time slot, so much time that any request that might be transmitted in the immediately subsequent time slot is lost in the present embodiment. By ignoring (in the present cycle 614) any requests received in a time slot 616 that has already been processed (in a previous cycle 614), an authorization request that arrived and was lost during the previous cycle 614 can be received and properly considered in the present cycle 614.

If there has not yet been any authorization request for the current time slot 616, then in step 1322 the site controller 210 determines whether it is receiving valid data during the current time slot 616. The check for validity of data is intended only to screen out noise. If no valid data is being received during the current time slot 616, then site controller 210 returns to loop 1318 to await the next time slot 616. If valid data is being received, then in step 1324 the site controller 210 marks the current time slot 616 active, thereby ensuring that another transmission during the present time slot 616 but in a subsequent cycle 614 will be ignored as described above with respect to step 1320. In step 1326, site controller 210 then checks the received nozzle module ID and vehicle module ID against the whitelists stored in the site computer 126. If one or both are not listed, then either the nozzle module 314 or the vehicle module 414 or both are not authorized to request authorization for the dispensing of fuel. In an embodiment, the whitelist database for the nozzle module IDs also indicates the particular nozzle 128 on which each nozzle module 314 has been installed. In this case the site controller 210 rejects the authorization request also if the nozzle number indicated in the whitelist for the nozzle module ID received during a particular time slot disagrees with the nozzle number associated with the particular time slot.

If authorization is to be rejected, then in step 1328 the rejection may be reported to an operator either at that time, or via a delayed reporting mechanism such as a log file. The site controller 210 then returns to step 1318 to await the next time slot 616. As mentioned, because the processing of steps 1320, 1322, 1324 and 1326 could occupy a significant amount of time, the next time slot to be considered in loop 1318 might not be the one immediately following the current one.

If the site controller 210 in step 1326 does verify the authority of the nozzle module 314 and vehicle module 414 to request authorization for the dispensing of fuel through the nozzle 128 corresponding to the current time slot, then in step 1330 the site controller 210 proceeds to send authorization to the dispenser 116 for the particular nozzle 128. The site controller 210 then returns to step 1318 to await the next time slot 616. Again, the next time slot might not be the one immediately following the current one. Note that there is no need for the site controller 210 to terminate authorization to a particular dispenser 116 when fueling completes, since the dispenser 116 automatically terminates its own authorization when the nozzle is replaced on-hook. The fueling record which the dispenser 116 later transmits to the site controller 210 is received by the site controller 210 and recorded in a database by a process not shown in FIG. 13.

After loop 1318 proceeds through all N time slots, the site controller 210 returns to loop 1316 to repeat the process for the next cycle of time slots. After all M cycles, the site controller 20 returns to step 1310 to await the next beacon signal.

In an embodiment, the site operator is provided in advance with a supply of spare nozzle modules 314, all of which are pre-recorded in the nozzle module ID whitelist. A separate supply of nozzle modules 314 is provided for each nozzle 128. When a nozzle module fails or is misplaced, the operator can simply substitute one of the spares for that particular nozzle. When the site controller 210 later receives an authorization request for the particular nozzle, but specifying the ID of one of the spare nozzle modules for that nozzle, the site controller 210 automatically retires the previous nozzle module ID from the whitelist. In this way, operators generally do not need to be trained in how to add or remove a module IDs from the whitelist.

In another embodiment, similar to the last-mentioned embodiment, the IDs for the supply of spare nozzle modules 314 is not pre-recorded in the nozzle module ID whitelist. Instead, all of the spare nozzle modules 314 for a particular nozzle number include that nozzle number in the low order bits of the nozzle module ID. After installation of a spare nozzle module on a particular nozzle, when the site controller 210 receives an authorization request for the particular nozzle, but specifying a new nozzle module ID, the site controller 210 merely checks that the low order bits of the new nozzle module ID match the nozzle number corresponding to the time slot in which the new nozzle module ID was received. If it does, then the site controller 210 automatically retires the previous nozzle module ID from the whitelist, and adds in the new nozzle module ID. This embodiment not only minimizes any need to train site operators in how to add or remove a module IDs from the whitelist, but also minimizes any need for the nozzle module ID whitelist to ever be updated manually. The high order bits of the nozzle module ID can, in this embodiment, be used to designate a product or version number rather than a code that renders the nozzle module identifier globally unique, and the site controller 210 can check this information against a product or version number stored in its database if desired.

Note that the fueling control system described herein can also be integrated with a telematics system. In such an embodiment, a telematics module is located in the vehicle and is always powered. It collects and stores information about the vehicle, such as mileage and any engine maintenance codes. When the site controller receives the vehicle module ID, the whitelist that it checks for authority to request authorization to dispense fuel also indicates the ID number of the vehicle's telematics module. The master interrogator 124, in addition to the other functions described herein, also transmits a polling request identifying the telematic module ID. The telematics module then responds by transmitting all its stored data and the site controller 210 reports it to a database.

As used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly.

Also as used herein, the “identification” of an item of information does not necessarily require the direct specification of that item of information. Information can be “identified” in a data field by simply referring to the actual information through one or more layers of indirection, or by identifying one or more items of different information which are together sufficient to determine the actual item of information. In addition, the term “indicate” is used herein to mean the same as “identify”.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

I claim as follows:

1. A fueling control system, comprising a nozzle module for use with a particular fuel dispensing nozzle, a vehicle module for use with a particular fuel tank inlet, and a site controller,
wherein the nozzle module, in response to predefined user activation behavior, wirelessly transmits a wake-up signal and an identification of the particular nozzle;
wherein the vehicle module, in response to detection of the wake-up signal:
awakens from a low power mode to an active mode,
detects the transmitted nozzle identification, and
wirelessly requests authorization for the particular nozzle to dispense fuel;
and wherein the site controller, in response to detection of the nozzle identification, authorizes dispensing of fuel through the particular nozzle.

2. A system according to claim 1, wherein the wake-up signal includes the identification of the particular nozzle.

3. A system according to claim 1, wherein the nozzle module, in response to the predefined user activation behavior, also wirelessly transmits an identification of the nozzle module,
wherein the vehicle module, also in response to detection of the wake-up signal, detects and wirelessly re-transmits the nozzle module identification;
and wherein the site controller, in response to detection of the nozzle module identification, verifies the authority of the nozzle module before authorizing dispensing of fuel through the particular nozzle.

4. A system according to claim 1, wherein the vehicle module, also in response to detection of the wake-up signal, wirelessly transmits an identification of the vehicle module,
and wherein the site controller, in response to detection of the vehicle module identification, verifies the authority of the vehicle module before authorizing dispensing of fuel through the particular nozzle.

5. A system according to claim 1, wherein the nozzle module, in response to the predefined user activation behavior, also wirelessly transmits an identification of the nozzle module,
wherein the vehicle module, also in response to detection of the wake-up signal:
detects and wirelessly re-transmits the nozzle module identifications; and
wirelessly transmits an identification of the vehicle module,
and wherein the site controller, in response to detection of the nozzle module identification and the vehicle module identification, verifies the authority of the nozzle module and the vehicle module before authorizing dispensing of fuel through the particular nozzle.

6. A system according to claim 5, wherein the vehicle module transmits a beacon signal in response to detection of the wake-up signal;
wherein the site controller detects the beacon signal, and in response thereto, transmits a synchronization signal;
and wherein the vehicle module detects the synchronization signal, and in response thereto, transmits a data signal during a time slot after the synchronization signal which is allocated to the particular nozzle, the data signal including the nozzle module identification and the vehicle module identification,
wherein the authorization request for the particular module by the vehicle module comprises the data signal transmitted during the time slot allocated to the particular nozzle.

7. A system according to claim 1, wherein the transmission of the nozzle identification by the nozzle module has a shorter range than the transmission of the nozzle identification by the vehicle module.

8. A system according to claim 1, wherein the nozzle module is battery powered.

9. A system according to claim 1, wherein the vehicle module is powered by a battery dedicated to the vehicle module.

10. A system according to claim 1, wherein the nozzle module comprises a switch having a first position when the particular nozzle is on-hook, the particular nozzle having a first angle to the vertical when on-hook, the switch further having a second position when the particular nozzle tilts away from the vertical by more than a predetermined tilt angle relative to the first angle, the predetermined tilt angle exceeding 45 degrees,
and wherein the user activation behavior comprises tilting the particular nozzle by more than the predetermined angle.

11. A system according to claim 1, wherein the vehicle module transmits a beacon signal in response to detection of the wake-up signal;
wherein the site controller detects the beacon signal, and in response thereto, transmits a synchronization signal;
and wherein the vehicle module detects the synchronization signal, and in response thereto, transmits a data signal during a time slot after the synchronization signal which is allocated to the particular nozzle,
wherein the authorization request for the particular module by the vehicle module comprises the data signal transmitted during the time slot allocated to the particular nozzle.

12. A fueling control module, for attachment to a fuel dispensing nozzle, comprising:
a switch having a first position when the nozzle is on-hook, the nozzle having a first angle to the vertical when the nozzle is on-hook, the switch further having a second position when the nozzle tilts away from the vertical by more than a predetermined tilt angle relative to the first angle, the predetermined tilt angle exceeding 45 degrees; and
a transmitter that wirelessly transmits an identifier of the nozzle in response to the switch transitioning from the first position to the second position.

13. A fueling dispenser control module, for use in association with a particular fuel dispensing nozzle, comprising:
a power control section having a power source input and a power providing output; and
a transmitter section having a power input connected to receive power from the power providing output of the power control section,
wherein the power control section provides power from the power source input to the power providing output in response to predefined user activation behavior, and shuts off power to the power providing output in response to a shutdown signal from the transmitter section;
and wherein the transmitter section, in response to receipt of power from the power providing output of the power control section:
wirelessly transmits an identification of the particular nozzle and an identification of the fueling dispenser control module; and thereafter,
asserts the shutdown signal to the power control section.

14. A module according to claim 13, wherein the transmitter section transmits the nozzle identification and the module identification a predetermined number of times, and then asserts the shutdown signal before making any further wireless transmissions.

15. A module according to claim 13, further comprising a battery, dedicated to the fueling dispenser control module, connected to the power source input of the power control section.

16. A fueling control module, comprising a power control section having a power source input and a power providing output; and
a transceiver section having a power input connected to receive power from the power providing output of the power control section,
wherein the power control section provides power from the power source input to the power providing output in response to detection of a wirelessly received wake-up signal;
and wherein the transceiver section, in response to receipt of power from the power providing output of the power control section:
obtains a nozzle identification from the wake-up signal, and
wirelessly requests authorization for the identified nozzle to dispense fuel.

17. A module according to claim 16, wherein the transceiver section further obtains a nozzle module identification from the wake-up signal, and
transmits the nozzle module identification with the wireless request for authorization for the identified nozzle to dispense fuel.

18. A module according to claim 17, wherein the transceiver section further transmits an identification of the fueling control module with the wireless request for authorization for the identified nozzle to dispense fuel.

19. A module according to claim 16, wherein the transceiver section transmits a beacon signal in response to receipt of power from the power providing output of the power control section;
wherein the transceiver section receives a synchronization signal after transmitting the beacon signal;
and wherein the transceiver section transmits a data signal in response to the synchronization signal, during a time slot after the synchronization signal which is allocated to the identified nozzle,
wherein the authorization request for the identified nozzle comprises the data signal transmitted during the time slot allocated to the identified nozzle.

20. A module according to claim 19, wherein the transceiver section further obtains a nozzle module identification from the wake-up signal, and
wherein the data signal includes both the nozzle module identification and an identification of the fueling control module.

21. A module according to claim 19, for use with a protocol in which N time slots each of predefined duration are allocated to N potential transmitters in sequence, the sequence repeating M times, N>1 and M>1, a particular one of the time slots being the one allocated to the identified nozzle,
wherein the transceiver section transmits the data signal during the particular time slot during each of the repetitions of the sequence.

22. A module according to claim 21, wherein the power control section shuts off power to the power providing output in response to a shut-down signal,
and wherein the transceiver section asserts the shut-down signal after transmitting the data signal for the M′th time after the synchronization signal, and before making any further transmissions.

23. A module according to claim 16, further comprising a battery, dedicated to the fueling control module, connected to the power source input of the power control module.

24. A method for controlling the filling of fuel tanks from a plurality of fuel dispensers, comprising the steps of:
in response to detection of a wirelessly transmitted beacon signal, transmitting a synchronization signal;
during a sequence of N time slots each of predefined duration following the transmission of the synchronization signal, detecting a data transmission during an i′th one of the time slots, N>1 and 0<i<=N, each of the fuel dispensers corresponding to a respective one of the time slots including the i′th time slot; and
authorizing the fuel dispenser corresponding to the i′th time slot in response to the step of detecting a data transmission during the i′th time slot.

25. A method according to claim 24, wherein the data detected during the i′th time slot includes an identification of a dispenser fuel control module,
further comprising the step of verifying authority of the identified dispenser fuel control module to request authorization to dispense fuel through the fuel dispenser corresponding to the i′th time slot, before the step of authorizing.

26. A method according to claim 24, wherein the data detected during the i′th time slot includes an identification of a vehicle fuel control module,
further comprising the step of verifying authority of the identified vehicle fuel control module to request authorization to dispense fuel, before the step of authorizing.

27. A method according to claim 26, wherein the data detected during the i′th time slot further includes an identification of a dispenser fuel control module,
further comprising the step of verifying authority of the identified dispenser fuel control module to request authorization to dispense fuel through the fuel dispenser corresponding to the i′th time slot, before the step of authorizing.

28. A method according to claim 24, further comprising the steps of:
during the sequence of N time slots, detecting a data transmission during a j′th one of the time slots, 0<j<=N, a j′th one of the fuel dispensers corresponding to the j′th time slot; and
authorizing the fuel dispenser corresponding to the j′th time slot in response to the step of detecting a data transmission during the j′th time slot.

29. A method according to claim 24, further comprising the steps of:
during a second repetition of the sequence of N time slots, detecting a data transmission during a j′th one of the time slots, 0<j<=N, a j′th one of the fuel dispensers corresponding to the j′th time slot; and
authorizing the fuel dispenser corresponding to the j′th time slot in response to the step of detecting a data transmission during the j′th time slot.
